(19) United States
(12) Patent Application Publication
(10) Pub. No.: US 2024/0222699 A1
(43) Pub. Date: Jul. 4, 2024

(54) ALL-SOLID-STATE BATTERY

(71) Applicant: TDK CORPORATION, Tokyo (JP)

(72) Inventors: Kazumasa TANAKA, Tokyo (JP); Keitaro OTSUKI, Tokyo (JP); Keiko TAKEUCHI, Tokyo (JP); Hiroshi SATO, Tokyo (JP)

(73) Assignee: TDK CORPORATION, Tokyo (JP)

(21) Appl. No.: 18/567,651

(22) PCT Filed: Jun. 29, 2022
(86) PCT No.: PCT/JP2022/025978

§ 371 Date: Dec. 6, 2023

(30) Foreign Application Priority Data
Jul. 5, 2021 (JP) 2021-111458

(51) Int. Cl. H01M 10/0562; H01M 4/02; H01M 4/133; H01M 4/134; H01M 10/0525

(52) U.S. Cl. CPC H01M 10/0562; H01M 4/133; H01M 4/134; H01M 10/0525; H01M 2004/027; H01M 2300/0068

(57) ABSTRACT

This all-solid-state battery includes: a positive electrode including a positive electrode active material layer; a negative electrode including a negative electrode active material layer; and a solid electrolyte layer located between the positive electrode active material layer and the negative electrode active material layer. The negative electrode active material layer contains a titanium compound. The solid electrolyte layer contains an LAGP compound represented by Li₁₊ₓAlₓGe₂₋ₓ(PO₄)₃ (x is a number which satisfies 0<x<1). Either one or both of an inside of the negative electrode active material layer and an interface between the negative electrode active material layer and the solid electrolyte layer contain an LATGP compound represented by Li_{1+y}Al_{y}Ti_{z}Ge_{2-y-z}(PO₄)₃ (y and z are numbers which satisfy 0<y<1 and 0<z<1).

### TECHNICAL FIELD

The present invention relates to an all-solid-state battery.

The present application claims priority on Japanese Patent Application No. 2021-111458 filed on Jul. 5, 2021, the content of which is incorporated herein by reference.

### BACKGROUND ART

Lithium ion secondary batteries which represent secondary batteries are lightweight and compact and have high capacity; and therefore, the lithium ion secondary batteries are widely used in various applications such as notebook computers, mobile phones, digital cameras, and automobiles. Currently, in the commonly used lithium ion secondary batteries, a liquid electrolyte containing a lithium salt in an organic solvent is used. For this reason, strict safety measures against flammability, leakage, short circuits, overcharging, and the like are required to be taken with lithium ion secondary batteries. From this point of view, research and development on all-solid-state batteries using solid electrolytes as electrolytes have been actively conducted in recent years.

All-solid-state batteries include a laminated body including a positive electrode active material layer containing a positive electrode active material, a negative electrode active material layer containing a negative electrode active material, and a solid electrolyte layer containing a solid electrolyte located between the positive electrode active material layer and the negative electrode active material layer and are broadly classified in accordance with the type of solid electrolyte. The types of solid electrolyte are mainly oxide-based solid electrolytes and sulfide-based solid electrolytes, and the oxide-based solid electrolytes have particularly excellent chemical stability. As an all-solid-state battery using the oxide-based solid electrolyte, for example, an all-solid-state battery using a solid electrolyte having a Nasicon-type crystal structure has been reported.

For example, Patent Document 1 discloses a laminated body for an all-solid-state lithium secondary battery including an active material layer and a solid electrolyte layer joined to the active material layer in a sintering way, in which a component other than constituent components of the active material layer and constituent components of the solid electrolyte layer are not detected in the laminated body at the time of analyzing the laminated body through an X-ray diffraction method.

Also, Patent Document 2 discloses a sintered body for a battery which contains a solid electrolyte material represented by the general expression Li₁₊ₓAlₓGe₂₋ₓ(PO₄)₃ (0≤x≤2) and an active substance material containing Li, Ti, and O and a component other than the solid electrolyte material and the active substance material is detected in an interface between the solid electrolyte material and the active substance material at the time of analyzing the sintered body for a battery through an X-ray diffraction method.

Furthermore, Patent Document 3 discloses an all-solid-state battery which includes a negative electrode layer, a solid electrolyte layer laminated on the negative electrode layer, and an interposition layer interposed between the negative electrode layer and the solid electrolyte layer, and in which the interposition layer contains a second solid electrolyte material different from a first solid electrolyte material contained in the solid electrolyte layer and the second solid electrolyte material has a potential window wider than that of the first solid electrolyte material.

### CITATION LIST

### Patent Document

[Patent Document 1] Japanese Unexamined Patent Application, First Publication No. 2007-5279
[Patent Document 2] Japanese Unexamined Patent Application, First Publication No. 2012-104280
[Patent Document 3] PCT International Publication No. WO 2013/137224

### SUMMARY OF INVENTION

### Technical Problem

Although it is effective to control an interface composition at an interface between a solid electrolyte layer and an active material layer for improving the discharge characteristics of all-solid-state batteries as described above, the interface resistance may become larger in accordance with a material composition of the interface and the discharge characteristics may deteriorate such as a decrease in discharge capacity during high-rate discharge. In this respect, in order to obtain higher discharge characteristics, further improvements are needed in the material composition at the interface between the solid electrolyte layer and the active material layer.

The present invention was made to solve the above problems, and an object of the present invention is to provide an all-solid-state battery which has a high discharge capacity during high-rate discharge and has excellent discharge characteristics.

### Solution to Problem

The inventors of the present invention found, as a result of careful consideration, that, in an all-solid-state battery in which a negative electrode active material layer contains at least a titanium compound and a solid electrolyte layer contains an LAGP compound represented by Li₁₊ₓAlₓGe₂₋ₓ(PO₄)₃ (0<x<1), an LATGP compound represented by Li_{1+y}Al_{y}Ti_{z}Ge_{2-y-z}(PO₄)₃ (0<y<1, 0<z<1) is contained in either one or both of an inside of the negative electrode active material layer and an interface between the negative electrode active material layer and the solid electrolyte layer, and thus the discharge capacity during high-rate discharge increases. That is to say, the present invention provides the following solutions to solve the above problems.
[1] An all-solid-state battery includes: a positive electrode including a positive electrode active material layer; a negative electrode including a negative electrode active material layer; and a solid electrolyte layer located between the positive electrode active material layer and the negative electrode active material layer, wherein
the negative electrode active material layer contains at least a titanium compound,
the solid electrolyte layer contains an LAGP compound represented by the following Expression (1):

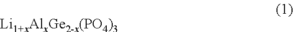

(in Expression (1), x is a number which satisfies 0<x<1), and
either one or both of an inside of the negative electrode active material layer and an interface between the negative electrode active material layer and the solid electrolyte layer contain an LATGP compound represented by the following Expression (2):

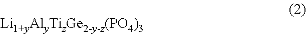

(in Expression (2), y and z are numbers which satisfy 0<y<1 and 0<z<1).
[2] In the all-solid-state battery according to the above [1], the titanium compound may contain either one or both of TiO₂ and Li₄Ti₅O₁₂.
[3] In the all-solid-state battery according to the above [1] or [2], in the Expression (2), y and z may be numbers which satisfy 0.11≤y+z≤1 and 0.01≤z/y≤9.
[4] In the all-solid-state battery according to any one of the above [1] to [3], the negative electrode active material layer may contain either one or both of a carbon-based material and the LAGP compound represented by the Expression (1).
[5] In the all-solid-state battery according to any one of the above [1] to [4], the solid electrolyte layer may have a porosity of 40% or less.

### Advantageous Effects of Invention

According to the present invention, it is possible to provide an all-solid-state battery which has a high discharge capacity during high rate discharge and has excellent discharge characteristics.

### BRIEF DESCRIPTION OF DRAWINGS

FIG. 1 is a schematic cross-sectional view of an all-solid-state battery according to an embodiment.

FIG. 2 is a schematic cross-sectional view of a solid electrolyte layer and a negative electrode active material layer and a positive electrode active material layer which are in the vicinity of the solid electrolyte layer in the all-solid-state battery according to the embodiment.

FIG. 3 is a schematic cross-sectional view of a solid electrolyte layer and a negative electrode active material layer and a positive electrode active material layer which are in the vicinity of the solid electrolyte layer in an all-solid-state battery according to a first modified example.

FIG. 4 is a schematic cross-sectional view of a solid electrolyte layer and a negative electrode active material layer and a positive electrode active material layer which are in the vicinity of the solid electrolyte layer in an all-solid-state battery according to a second modified example.

### DESCRIPTION OF EMBODIMENTS

Embodiments will be described in detail below with reference to drawings as appropriate. The drawings used in the following explanation may show characteristic parts enlarged for convenience to make the characteristics of the present invention easier to understand in some cases. In addition, the dimensional proportions and the like of each constituent element may differ from the actual one in some cases. The materials, the dimensions, and the like exemplified in the following description are merely examples and the present invention is not limited thereto. It is possible to modify and implement it as appropriate without changing the gist of the present invention.

### [All-Solid-State Battery]

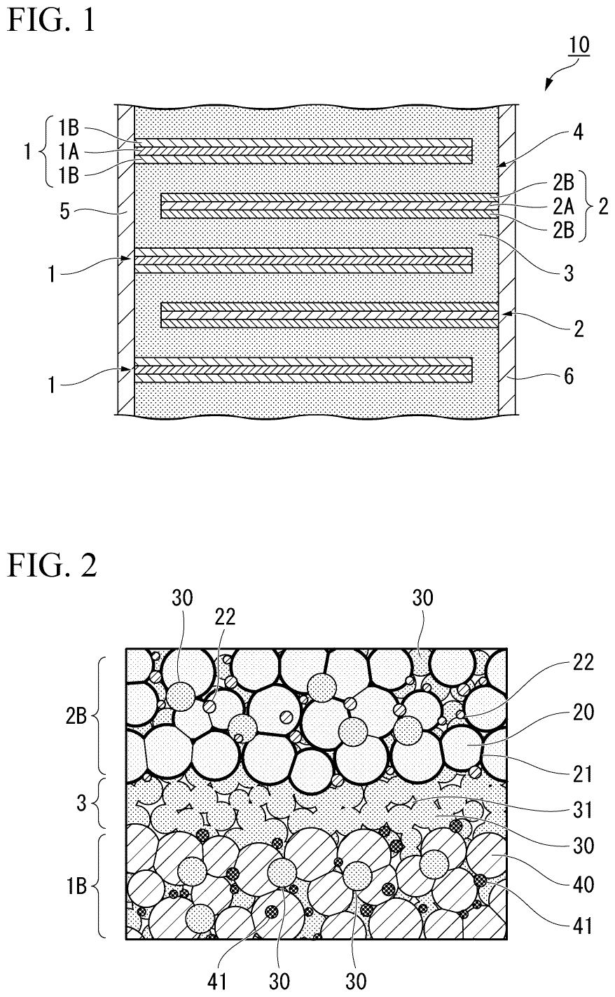

FIG. 1 is a schematic cross-sectional view of an all-solid-state battery 10 according to the embodiment. The all-solid-state battery 10 includes a laminated body 4, a positive electrode terminal 5, and a negative electrode terminal 6. The positive electrode terminal 5 and the negative electrode terminal 6 are in contact with opposing surfaces of the laminated body 4, respectively. The positive electrode terminal 5 and the negative electrode terminal 6 extend in a direction intersecting (orthogonal to) a lamination surface of the laminated body 4.

The laminated body 4 includes a positive electrode 1, a negative electrode 2, and a solid electrolyte layer 3. Any number of layers of the positive electrode 1 and the negative electrode 2 may be provided. The solid electrolyte layer 3 is located between the positive electrode 1 and the negative electrode 2, between the positive electrode 1 and the negative electrode terminal 6, or between the negative electrode 2 and the positive electrode terminal 5. The positive electrode 1 has one end which is connected to the positive electrode terminal 5. The negative electrode 2 has one end which is connected to the negative electrode terminal 6.

The all-solid-state battery 10 is charged or discharged through exchanging of ions between the positive electrode 1 and the negative electrode 2 via the solid electrolyte layer 3. Although FIG. 1 shows a laminated type battery, a wound type battery may also be used. The all-solid-state battery 10 is used, for example, as a laminate battery, a square type battery, a cylindrical type battery, a coin type battery, a button type battery, or the like.

### “Solid Electrolyte Layer”

The solid electrolyte layer 3 includes a solid electrolyte. The solid electrolyte is a material which can move ions using an electric field applied from the outside. The solid electrolyte layer 3 has lithium ion conductivity and inhibits the movement of electrons. The solid electrolyte layer 3 is, for example, a sintered body obtained through sintering.

The solid electrolyte layer 3 includes an LAGP compound represented by the following Expression (1):

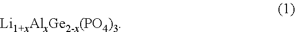

In Expression (1), x is a number which satisfies 0<x<1. x is not particularly limited, but is preferably a number which satisfies 0.1≤x≤0.9.

The solid electrolyte layer 3 may be a sintered body made of a powder of the LAGP compound described above. The solid electrolyte layer 3 may contain materials other than LAGP compound. For example, the solid electrolyte layer 3 can contain a binder for a solid electrolyte. The same material as a binder for a positive electrode and a binder for a negative electrode which will be described later can be used as the binder for a solid electrolyte. In the solid electrolyte layer 3, an amount of the LAGP compound is not particularly limited, but is preferably 80% by mass or more.

Also, the solid electrolyte contained in the solid electrolyte layer 3 may consist of one type of LAGP compound or may be a mixture containing an LAGP compound and other solid electrolytes. Examples of other solid electrolytes can include general solid electrolytes such as oxide-based lithium ion conductors having any one of Nasicon type, garnet type, and perovskite type crystal structures. As the oxide-based lithium ion conductors having a Nasicon type crystal structure, a solid electrolyte containing at least Li, M (M is at least one of Ti, Zr, Ge, Hf, and Sn), P, and O (for example, Li₁₊ₓAlₓTi₂₋ₓ(PO₄)₃: LATP) can be used. As the oxide-based lithium ion conductor having a garnet type crystal structure, a solid electrolyte containing at least Li, Zr, La, and O (for example, Li₇La₂Zr₂O₁₂; LLZ) can be used. As the oxide-based lithium ion conductor having a perovskite structure, a solid electrolyte containing at least Li, Ti, La, and O (for example, Li₃ₓLa_{2/3-x}TiO₃; LLTO) can be used.

The solid electrolyte layer 3 may have a porosity of 40% or less. The porosity is a value expressed as a percentage of an area of a space in which a solid electrolyte does not exist relative to an observation area at the time of observing the cross section of the solid electrolyte layer. A scanning electron microscope (SEM) can be used for observing the cross section of the solid electrolyte layer. The porosity of the solid electrolyte layer 3 is not particularly limited, but is more preferably 30% or less, and even more preferably 20% or less.

### “Positive Electrode”

As shown in FIG. 1, the positive electrode 1 includes, for example, a positive electrode current collector layer 1A containing at least a conductive material and a positive electrode active material layer 1B containing at least a positive electrode active material.

### (Positive Electrode Current Collector Layer)

The positive electrode current collector layer 1A contains at least a conductive material. Furthermore, the positive electrode current collector layer 1A may contain a binder for a positive electrode and the solid electrolyte (LAGP compound) described above. The positive electrode current collector layer 1A may have a form such as a powder, a foil, a punching shape, or an expanded shape.

Examples of the conductive material include silver, palladium, gold, platinum, aluminum, copper, nickel, carbon, and the like. An amount of the conductive material contained in the positive electrode current collector layer 1A is not particularly limited, but is preferably 10% by mass or more. Examples of the above-described carbon include graphite, carbon black, acetylene black, Ketjen black, graphene, carbon nanotubes, vapor grown carbon fiber (VGCF), and the like.

A binder for a positive electrode can be contained within a range in which it does not impair the function of the positive electrode current collector layer 1A. An amount of the binder for a positive electrode in the positive electrode current collector layer 1A can be within, for example, the range of 0.5 to 30% by mass. If the amount of the binder for a positive electrode is less than 0.5% by mass, the bonding properties of the various materials which constitute the positive electrode current collector layer 1A become insufficient and the internal resistance of the positive electrode current collector layer 1A may become high in some cases. If the amount of the binder for a positive electrode is more than 30% by mass, the binder for a positive electrode becomes a resistance component and the internal resistance of the positive electrode current collector layer 1A may become high. The binder for a positive electrode may not need to be contained if unnecessary.

As the binder for a positive electrode, for example, an organic binder or an inorganic binder can be used. As examples of the organic binder, polyvinylidene fluoride (PVDF), polytetrafluoroethylene (PTFE) cellulose, polyvinyl butyral, ethyl cellulose, styrene-butadiene rubber (SBR), ethylene-propylene rubber, polyacrylate (PAA), polyimide resin (PI), polyamideimide resin (PAI), and the like can be used. Furthermore, as the organic binder, a conductive polymer having electron conductivity or an ion conductive polymer having ion conductivity may be used. Examples of the conductive polymer having electron conductivity include polyacetylene or the like. In this case, since the organic binder also functions as the conductive auxiliary agent particles, it may not be necessary to add the conductive agent in some cases. As the ion conductive polymer which has ion conductivity, for example, a material which conducts lithium ions or the like can be used, and materials obtained by combining a monomer of a polymer compound (polyether-based polymer compound such as polyethylene oxide, polypropylene oxide, and the like, polyphosphazene, and the like) with a lithium salt such as LiClO₄, LiBF₄, and LiPF₆ or an alkali metal salt which mainly includes lithium can be exemplified. As a polymerization initiation agent used for combination, for example, an optical polymerization initiation agent, a thermal polymerization initiation agent, or the like which is compatible with the above-described monomers can be used. As examples of the inorganic binder, lithium halide, silicate compounds, phosphate compounds, low melting point glass, or the like can be used. As the characteristics required for the binder for a positive electrode, the binder has oxidation/reduction resistance and satisfactory adhesion.

Furthermore, the positive electrode current collector layer 1A can contain a solid electrolyte to the extent that a function thereof as a positive electrode current collector layer is not impaired. It is preferable that the solid electrolyte be the LAGP compound contained in the solid electrolyte layer 3 described above. In addition, in a case where a sintering process is included in the production of the all-solid-state battery, the solid electrolyte contained in the positive electrode current collector layer 1A relieves the shrinkage stress of the positive electrode current collector layer 1A due to sintering and suppresses cracks and fractures caused by this shrinkage stress.

### (Positive Electrode Active Material Layer)

The positive electrode active material layer 1B is formed on either one or both sides of the positive electrode current collector layer 1A. The positive electrode active material layer 1B contains at least positive electrode active material. The positive electrode active material layer 1B may contain a conductive auxiliary agent, a binder for a positive electrode, and the above-described solid electrolyte (LAGP compound).

### (Positive Electrode Active Material)

The positive electrode active material is not particularly limited as long as it can reversibly progress the release and insertion of lithium ions and the desorption and insertion of lithium ions. For example, a positive electrode active material used in known lithium ion secondary batteries can be used.

The positive electrode active material is, for example, a transition metal oxide, a composite transition metal oxide, or the like.

Examples of the positive electrode active material include transition metal oxides represented by lithium cobalt oxide (LiCoO₂), lithium nickel oxide (LiNiO₂), and spinel lithium manganese oxide (LiMn₂O₄), complex transition metal oxides represented by the general Expression: LiNiₓCo_{y}Mn_{z}MₐO₂ (x+y+z+a=1, 0≤x≤1, 0≤y≤1, 0≤z≤1, 0≤a≤1: M is one or more elements selected from Al, Mg, Nb, Ti, Cu. Zn, and Cr), a lithium vanadium compound (LiV₂O₅, Li₃V₂(PO₄)₃, LiVOPO₄), an olivine type LiMPO₄ (where, M represents one or more elements selected from Co, Ni, Mn, Fe, Mg, V, Nb, Ti, Al, and Zr), LiNiₓCo_{y}Al_{z}O₂ (0.9<x+y+z<1.1), and the like.

As the positive electrode active material in the present disclosure, it is preferable that a phosphoric acid compound be used, it is preferable that one or more of lithium vanadium phosphate (LiVOPO₄, Li₃V₂(PO₄)₃, Li₄(VO)(PO₄)₂), lithium vanadium pyrophosphate (Li₂VOP₂O₇, Li₂VP₂O₇), and Li₉V₃(P₂O₇)₃(PO₄)₂ be used, and it is particularly preferable that either one or both of LiVOPO₄ and Li₃V₂(PO₄)₃ be used.

An amount of the positive electrode active material in the positive electrode active material layer 1B is not particularly limited, but is preferably 40% by mass or more.

The conductive auxiliary agent contained in the positive electrode active material layer 1B is not particularly limited as long as it improves the electron conductivity in the positive electrode active material layer 1B and any known conductive auxiliary agent can be used. Examples of the conductive auxiliary agent include a carbon-based material such as graphite, carbon black, acetylene black, Ketjen black, graphene, carbon nanotubes, and vapor grown carbon fiber (VGCF), a metal such as gold, platinum, silver, palladium, aluminum, copper, nickel, stainless steel, and iron, a conductive oxide such as ITO, or a mixture thereof. The conductive auxiliary agent may have a shape such as a powder shape and a fiber shape. It is preferable to use a carbon-based material as the conductive auxiliary agent.

The binder for a positive electrode joins the positive electrode current collector layer 1A with the positive electrode active material layer 1B, the positive electrode active material layer 1B with the solid electrolyte layer 3, and the various materials which constitute the positive electrode active material layer 1B with each other.

The binder for a positive electrode can be included in an amount within a range in which it does not impair the function of the positive electrode active material layer 1B. An amount of the binder for a positive electrode in the positive electrode active material layer 1B can be, for example, within the range of 0.5 to 70% by mass. The amount of the binder for a positive electrode in the positive electrode active material layer 1B may be, for example within the range of 0.5 to 30% by volume of the positive electrode active material layer. If the amount of the binder for a positive electrode is sufficiently small, the resistance of the positive electrode active material layer 1B becomes sufficiently low. The binder for a positive electrode does not need to be included if unnecessary.

As the binder for a positive electrode, an organic binder or an inorganic binder can be used as is the case with the binder for a positive electrode included in the positive electrode current collector layer 1A.

Also, the positive electrode active material layer 1B can contain a solid electrolyte to the extent that it does not impair a function thereof as a positive electrode active material layer. The amount of the solid electrolyte in the positive electrode active material layer 1B can be, for example, within the range of 1 to 50% by mass. It is preferable that the solid electrolyte be the LAGP compound contained in the solid electrolyte layer 3 described above. The solid electrolyte contained in the positive electrode active material layer 1B provides good lithium ion conductivity in the positive electrode active material layer 1B. Furthermore, in a case where a sintering process is included in the production of the all-solid-state battery, the solid electrolyte contained in the positive electrode active material layer 1B relieves the shrinkage stress of the positive electrode active material layer 1B due to sintering and suppresses cracks and fractures caused by this shrinkage stress.

### “Negative Electrode”

As shown in FIG. 1, the negative electrode 2 includes, for example, a negative electrode current collector layer 2A containing at least a conductive material and a negative electrode active material layer 2B containing at least a negative electrode active material.

### (Negative Electrode Current Collector Layer)

The negative electrode current collector layer 2A is similar to the positive electrode current collector layer 1A.

### (Negative Electrode Active Material Layer)

The negative electrode active material layer 2B is formed on either one or both sides of the negative electrode current collector layer 2A. The negative electrode active material layer 2B contains at least a negative electrode active material. Furthermore, the negative electrode active material layer 2B may contain a conductive auxiliary agent, a binder for a negative electrode, and the solid electrolyte (LAGP compound) described above. In addition, the LATGP compound is contained in either one or both of the inside of the negative electrode active material layer 2B and an interface between the negative electrode active material layer 2B and the solid electrolyte layer 3.

The titanium compound is contained as the negative electrode active material. The titanium compound is not particularly limited as long as it is a compound which can absorb and release ions. As the titanium compound, for example, TiO₂ and Li₄Ti₅O₁₂ can be used. Although there are TiO₂ having an anatase type crystal structure, TiO₂ having a brookite type crystal structure. TiO₂ having a rutile type crystal structure, and the like as TiO₂, in the embodiments in the present disclosure, the titanium compound is not limited to one of these types. One type of these titanium compounds may be used alone or a combination of two types thereof may be used.

The conductive auxiliary agent contained in the negative electrode active material layer 2B can be the same material as that in the positive electrode active material layer 1B. It is preferable to use a carbon-based material as the conductive auxiliary agent.

The binder for a negative electrode joins the negative electrode current collector layer 2A with the negative electrode active material layer 2B, the negative electrode active material layer 2B with the solid electrolyte layer 3, and the various materials which constitute the negative electrode active material layer 2B with each other.

The binder for a negative electrode can be contained in an amount within a range in which it does not impair the function of the negative electrode active material layer 2B. The amount of the binder for a negative electrode can be within the range of 0.5 to 70% by mass of the negative electrode active material layer 2B, as is the case with the positive electrode active material layer 1B. As the binder for a negative electrode, the same material as the binder for a positive electrode can be used. The binder for a negative electrode does not need to be contained if unnecessary.

Also, the negative electrode active material layer 2B can contain a solid electrolyte to the extent that it does not impair a function thereof as a negative electrode active material layer. For example, the amount of the solid electrolyte in the negative electrode active material layer 2B can be, for example, within the range of 1 to 50% by mass. It is preferable that the solid electrolyte be the LAGP compound contained in the solid electrolyte layer 3 described above. The solid electrolyte contained in the negative electrode active material layer 2B provides good lithium ion conductivity in the negative electrode active material layer 2B. Furthermore, in a case where a sintering process is included in the production of the all-solid-state battery, the solid electrolyte contained in the negative electrode active material layer 2B relieves the shrinkage stress of the negative electrode active material layer 2B due to sintering and suppresses cracks and fractures caused by this shrinkage stress.

### (LATGP Compound)

The LATGP compound is represented by the following Expression (2):

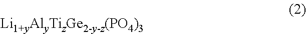

in Expression (2), y and z are numbers which satisfy 0<y<1 and 0<z<1. Although y and z are not particularly limited, it is preferable that they be numbers which satisfy 0.11≤y+z≤1 and 0.01≤z/y≤9.

FIG. 2 is a schematic cross-sectional view of a solid electrolyte layer and a negative electrode active material layer and a positive electrode active material layer which are in the vicinity of the solid electrolyte layer in the all-solid-state battery according to the embodiment. In FIG. 2, the solid electrolyte layer 3 is a sintered body of the LAGP compound powder 30. The positive electrode active material layer 1B contains a positive electrode active material powder 40 and a conductive auxiliary agent powder 41. The negative electrode active material layer 2B contains a titanium compound powder 20, a LATGP compound 21, a conductive auxiliary agent powder 22, and a LAGP compound powder 30. The LATGP compound 21 is contained in the negative electrode active material layer 2B in a form in which the LATGP compound 21 covers at least a part of the titanium compound powder 20. Thus, the titanium compound powder 20 and the LAGP compound powder 30 are in contact via the LATGP compound 21. Since the LATGP compound 21 and the LAGP compound powder 30 both contain Li, Al, Ge, and PO₄, they have a high affinity. In addition, since the LATGP compound 21 contains Ti, it has a high affinity with the titanium compound powder 20. Furthermore, since the LATGP compound 21 has a Nasicon type structure, the diffusion rate of lithium ions is fast. For this reason, when the titanium compound powder 20 and the LAGP compound powder 30 are in contact via the LATGP compound 21, the LATGP compound 21 acts as a conduction path for lithium ions; and thereby, the rate of lithium ion diffusion from the negative electrode active material layer 2B to the solid electrolyte layer 3 is increased during discharge. Thus, the discharge capacity at high rates becomes high. The coverage rate of the LATGP compound 21 covering the titanium compound powder 20 is not particularly limited, but is preferably 1% or more, more preferably 30% or more, and preferably 50% or more. In addition, the thickness of the LATGP compound 21 covering the titanium compound powder 20 is not particularly limited, but is preferably within the range of 1 nm or more and 1 μm or less, more preferably within the range of 1 nm or more and 100 nm or less, and more preferably within the range of 1 nm or more and 50 nm or less. The coverage rate and the thickness of the LATGP compound 21 can be measured by performing elemental analysis of the surface of the titanium compound powder 20 using scanning transmission electron microscopy-energy dispersive X-ray spectroscopy (STEM-EDS).

The titanium compound powder 20 whose surface is at least partially covered with the LATGP compound 21 can be produced, for example, using a sol-gel method. A Li source, an Al source, a Ti source, a Ge source, and a PO₄ source are weighed to have a desired composition of the LATGP compound, and these sources are dissolved in an organic solvent to obtain Solution A. Furthermore, Solution B is obtained by dispersing the titanium compound powder 20 in a phosphate solution in which phosphate is dissolved in ion-exchanged water. A sol of the LATGP precursor is generated on the surface of the titanium compound powder 20 by adding Solution A to Solution B and stirring the mixture. The titanium compound powder 20 covered with the LATGP compound 21 is obtained by washing the titanium compound powder 20 and then calcining it at a temperature of 400° C. or higher and 550° C. or lower.

There are no particular restrictions on materials used as a Li source, an Al source, a Ti source, a Ge source, and a PO₄ source, and as the Li source, the Al source, the Ti source, the Ge source, metal alkoxides, carbonates, nitrates, acetates, oxides, hydroxides, chlorides, phosphates, and the like can be used. Phosphate also acts as a source of PO₄. As the PO₄ source, phosphoric acid, ammonium dihydrogen phosphate, diammonium hydrogen phosphate, and the like can be used.

As another method for producing the titanium compound powder 20 covered with the LATGP compound 21, for example, a spray drying method can be used. A pre-prepared dispersion of the LATGP compound 21 in which a fine powder of the LATGP compound 21 is dispersed is mixed with the titanium compound powder 20 to obtain a mixture. The obtained mixture is dried using a spray dryer to obtain a dried powder. The obtained dried powder is fired to sinter the titanium compound powder 20 and the fine powder of the LATGP compound 21.

Although the method for coating the titanium compound powder with the LATGP compound is not particularly limited, from the viewpoint of coating properties and adhesion, a sol-gel method is preferred. The thickness of the LATGP compound can be easily controlled using a sol-gel method and the sol-gel method can be suitably used when coating the LATGP compound with a relatively thin thickness of 100 nm or less.

(Method for Producing all-Solid-State Battery)

A method for producing the all-solid-state battery 10 will be described below. First, the laminated body 4 is prepared. The laminated body 4 is prepared, for example, using a simultaneous sintering method or a sequential sintering method.

A simultaneous sintering method is a method in which the laminated body 4 is prepared by laminating materials forming each layer and then sintering them all at once. A sequential sintering method is a method in which sintering is performed each time each layer is formed. The simultaneous sintering method can prepare the laminated body 4 in fewer work steps than those of the sequential sintering method. Furthermore, the laminated body 4 prepared using the simultaneous sintering method is more dense than the laminated body 4 produced using the sequential sintering method. A case in which the simultaneous sintering method is used will be explained below as an example.

First, each material of the positive electrode current collector layer 1A, the positive electrode active material layer 1B, the solid electrolyte layer 3, the negative electrode active material layer 2B, and the negative electrode current collector layer 2A which constitute the laminated body 4 is made as a paste. As the negative electrode active material, a titanium compound powder whose surface is at least partially covered with the LATGP compound 21 is used.

The method for making each material as a paste is not particularly limited, and for example, a method may be used for obtaining a paste by mixing a powder of each material in a vehicle. The vehicle has a general term for a medium in a liquid phase. Examples of the vehicle include a solvent and a binder.

Subsequently, a green sheet is prepared. The green sheet is obtained by applying a paste prepared for each material onto a base material such as a polyethylene terephthalate (PET) film, drying it as necessary, and then peeling off the base material. The method for applying the paste is not particularly limited, and for example, known methods such as screen printing, coating, transferring, and a doctor blade can be used.

Subsequently, the green sheets prepared for the materials are laminated in a desired order and number of layers to prepare a laminated sheet. When laminating green sheets, alignment and cutting are performed as necessary. For example, in a case where parallel type or series-parallel type batteries are prepared, an end surface of the positive electrode current collector layer 1A and an end surface of the negative electrode current collector layer 2A are aligned so that they do not match and green sheets are laminated.

A laminated sheet may be prepared using a method in which a positive electrode unit and a negative electrode unit are prepared and then these units are laminated. The positive electrode unit is a laminated sheet in which the solid electrolyte layer 3, the positive electrode active material layer 1B, the positive electrode current collector layer 1A, and the positive electrode active material layer 1B are laminated in this order. The negative electrode unit is a laminated sheet in which the solid electrolyte layer 3, the negative electrode active material layer 2B, the negative electrode current collector layer 2A, and the negative electrode active material layer 2B are laminated in this order. The lamination is performed so that the solid electrolyte layer 3 of the positive electrode unit and the negative electrode active material layer 2B of the negative electrode unit face each other or the positive electrode active material layer 1B of the positive electrode unit and the solid electrolyte layer 3 of the negative electrode unit face each other.

Subsequently, the prepared laminated sheet is pressurized all at once to improve the adhesion of each layer. Pressurization can be carried out using, for example, a mold press, a hot water isostatic press (WIP), a cold water isostatic press (CIP), a hydrostatic press, or the like. It is preferable to perform pressurization while performing heating. The heating temperature during pressure bonding is, for example, 40 to 95° C. Subsequently, the pressurized laminated body is cut into chips using a dicing device. Furthermore, the laminated body 4 composed of a sintered body is obtained by subjecting the chip to degreasing of the binder and sintering.

A binder degreasing process can be performed as a separate process from the sintering process. When a binder degreasing step is performed, a binder component contained in the chip is thermally decomposed before the sintering process and rapid decomposition of the binder component during the sintering process can be suppressed. Although the atmosphere and heating conditions of the binder degreasing step are not limited, for example, heating is performed at a temperature of 300° C. or higher for 0.1 to 10 hours in an air atmosphere, a nitrogen atmosphere, an argon atmosphere, or an oxygen atmosphere. Although an upper limit temperature of the degreasing step is not particularly limited, it is preferably carried out at a temperature of the sintering temperature or lower.

The sintering process is, for example, performed by placing the chip on a ceramic stand. Sintering is performed, for example, by performing heating at a temperature of 600 to 1000° C. in a nitrogen atmosphere. A sintering time is, for example, 0.1 to 3 hours. A sintering step may be performed in a reducing atmosphere other than a nitrogen atmosphere, for example, in an argon atmosphere or a nitrogen-hydrogen mixed atmosphere.

Also, the sintered laminated body 4 (sintered body) may be put into a cylindrical container with an abrasive material such as alumina and subjected to barrel polishing. Thus, the corners of the laminated body can be chamfered. Polishing may be performed using sandblasting. Sandblasting is preferable because only specific portions can be removed.

The positive electrode terminal 5 and the negative electrode terminal 6 are formed on mutually opposing sides of the produced laminated body 4. The positive electrode terminal 5 and the negative electrode terminal 6 can each be formed using a sputtering method, a dipping method, a screen printing method, a spray coating method, or the like. The all-solid-state battery 10 can be prepared through the steps described above. In a case where the positive electrode terminal 5 and the negative electrode terminal 6 are formed only in predetermined portions, the process is performed after masking with tape or the like.

In the all-solid-state battery 10 according to the embodiment, the titanium compound powder 20 which is a negative electrode active material and the LAGP compound powder 30 which is a solid electrolyte are in contact via the LATGP compound 21. Thus, the discharge capacity during high rate discharge is high and the discharge characteristics are improved. Furthermore, in the all-solid-state battery 10 of the embodiment, in a case where the titanium compound powder 20 contains either one or both of TiO₂ and Li₄T₅O₁₂, these titanium compounds have a large amount of lithium ions intercalated and deintercalated during charge/discharge reactions. Thus, the charge/discharge capacity of the negative electrode active material layer 2B increases.

Also, in the all-solid-state battery 10 of the embodiment, in a case where the LATGP compound 21 contains Al and Ti so that y and z in the Expression (2) satisfy 0.11≤y+z≤1 and 0.01≤z/y≤9, the conductivity of lithium ions in the LATGP compound is further improved, the discharge capacity during high rate discharge is higher, and the discharge characteristics are further improved. In addition, in the all-solid-state battery 10 of the embodiment, in a case where the negative electrode active material layer 2B contains carbon-based material, the electron conductivity in the negative electrode active material layer 2B is improved, the discharge capacity during high rate discharge is further increased, and the discharge characteristics are further improved. Furthermore, in the all-solid-state battery 10 of the embodiment, in a case where the negative electrode active material layer 2B contains a LAGP compound, the lithium ion conductivity in the negative electrode active material layer 2B is improved, the discharge capacity during high rate discharge is further increased, and the discharge characteristics are further improved.

Furthermore, in the all-solid-state battery 10 of the embodiment, in a case where the porosity of the solid electrolyte layer 3 is 40% or less, the ion conductivity of lithium ions in the solid electrolyte layer 3 can be further improved. Thus, the discharge capacity during high rate discharge is further increased and the discharge characteristics are further improved.

Specific examples of the all-solid-state battery according to the embodiment have been described in detail above. The present invention is not limited to this example and various modifications and changes are possible within the scope of the features of the present invention described within the scope of the claims. For example, although the LATGP compound 21 is contained in the negative electrode active material layer 2B in a state where at least a part of the surface of the titanium compound powder 20 is coated with the LATGP compound 21 in the example shown in FIG. 2, the location in which the LATGP compound 21 is included is not limited to this.

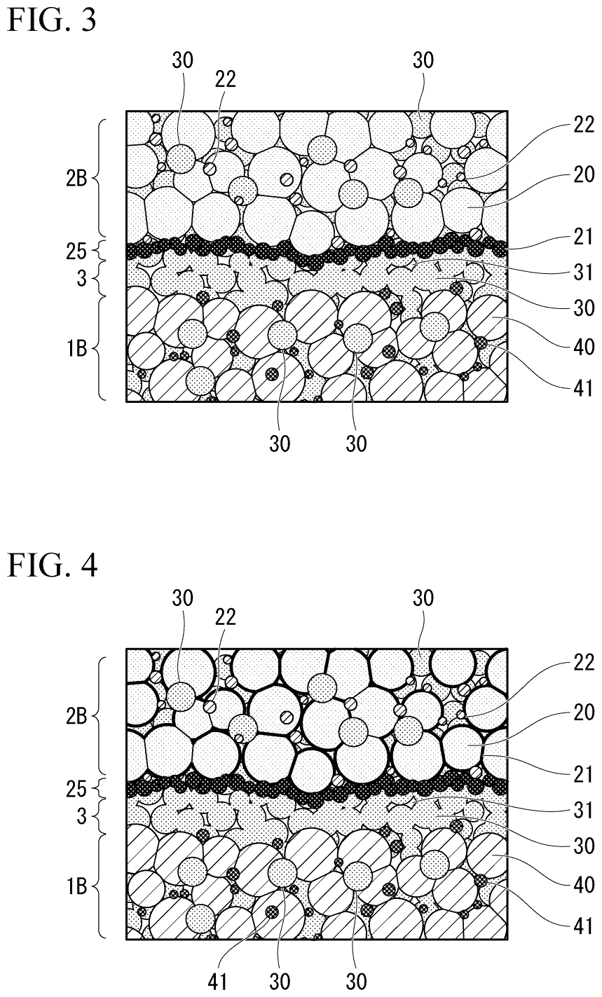

FIG. 3 is a schematic cross-sectional view of a solid electrolyte layer and a negative electrode active material layer and a positive electrode active material layer which are in the vicinity of the solid electrolyte layer in an all-solid-state battery according to a first modified example. The all-solid-state battery according to the first modified example shown in FIG. 3 differs from the all-solid-state battery shown in FIG. 2 in that, in the all-solid-state battery according to the first modified example shown in FIG. 3, an intermediate layer 25 containing the LATGP compound 21 is formed in an interface between the solid electrolyte layer 3 and the negative electrode active material layer 2B, instead of the titanium compound powder 20 being covered with the LATGP compound 21. The thickness of the intermediate layer 25 is not particularly limited, but is preferably within the range of 0.01 μm or more and 2.0 μm or less, more preferably within the range of 0.01 μm or more and 1.2 μm or less, and particularly preferably within the range of 0.1 μm or more and 0.5 μm or less.

An all-solid-state battery according to the first modified example can be produced by preparing a LATGP compound paste and applying the LATGP compound paste onto a surface of the solid electrolyte layer 3 and drying it, instead of coating the surface of the titanium compound powder 20 with the LATGP compound 21 at the time of preparing a negative electrode unit.

In the all-solid-state battery according to the first modified example, the negative electrode active material layer 2B containing the titanium compound powder 20 is in contact with the solid electrolyte layer 3 containing the LAGP compound powder 30 via the intermediate layer 25 containing the LATGP compound. Thus, the discharge capacity during high rate discharge is high and the discharge characteristics are improved.

FIG. 4 is a schematic cross-sectional view of a solid electrolyte layer and a negative electrode active material layer and a positive electrode active material layer which are in the vicinity of the solid electrolyte layer in an all-solid-state battery according to a second modified example. The all-solid-state battery according to the second modified example shown in FIG. 4 differs from the all-solid-state battery shown in FIG. 2 in that, in the all-solid-state battery according to the second modified example shown in FIG. 4, the titanium compound powder 20 is covered with the LATGP compound 21 and an intermediate layer 25 containing a LATGP compound is further formed in an interface between the solid electrolyte layer 3 and the negative electrode active material layer 2B.

The all-solid-state battery according to the second modified example can be produced by coating a surface of the titanium compound powder 20 with the LATGP compound 21, preparing the LATP compound paste, applying the LATGP compound paste to the surface of the solid electrolyte layer 3, and drying it at the time of preparing a negative electrode unit.

In the all-solid-state battery according to the second modified example, the titanium compound powder 20 and the LAGP compound powder 30 which is the solid electrolyte are in contact via the LATGP compound 21. Thus, the discharge capacity during high rate discharge is high and the discharge characteristics are improved. Furthermore, the negative electrode active material layer 2B containing the titanium compound powder 20 is in contact with the solid electrolyte layer 3 containing the LAGP compound powder 30 via the intermediate layer 25 containing the LATGP compound. Thus, the discharge capacity during high rate discharge is high and the discharge characteristics are improved.

In the all-solid-state battery 10 of the embodiment, the LATGP compound 21 may be included both on at least a part of the surface of the titanium compound powder 20 and in an interface between the solid electrolyte layer 3 and the negative electrode active material layer 2B. Furthermore, the LATGP compound 21 may further be contained in the solid electrolyte layer 3.

### EXAMPLES

### Example 1

### (1) Preparation of Solid Electrolyte Sheet

A solid electrolyte paste was prepared as follows. Li_{1.5}Al_{0.5}Ge_{1.5}(PO₄)₃ powder was used as a solid electrolyte. 100 parts by mass of ethanol and 200 parts by mass of toluene which served as solvents were added to 100 parts by mass of Li_{1.5}Al_{0.5}Ge_{1.5}(PO₄)₃ powder and mixed in a ball mill in a wet manner. After that, a solid electrolyte paste was obtained by further introducing, mixing, and dispersing 16 parts by mass of polyvinyl butyral serving as a binder for a solid electrolyte and 4.8 parts by mass of benzyl butyl phthalate serving as a plasticizer.

Subsequently, a PET film with a solid electrolyte layer was obtained by applying the obtained solid electrolyte paste onto the PET film using a doctor blade method and drying the obtained coating film at 80° C. for 5 minutes. The PET sheet was peeled off from the obtained PET film with a solid electrolyte layer to prepare a solid electrolyte sheet. A thickness of the solid electrolyte sheet was 15 μm.

### (2) Preparation of Positive Electrode Unit

A positive electrode active material paste was prepared as follows. Li₃V₂(PO₄)₃ powder was used as a positive electrode active material, acetylene black powder was used as a conductive auxiliary agent, and the solid electrolyte used in the above (1) was used as a solid electrolyte. Li₃V₂(PO₄)₃ powder, the acetylene black powder, and the solid electrolyte powder were mixed at a mass ratio of 45:10:45. Subsequently, a positive electrode active material paste was obtained by adding and mixing 15 parts by mass of ethyl cellulose serving as a binder for a positive electrode and 65 parts by mass of dihydroterpineol serving as a solvent to 100 parts by mass of the mixed powder.

A positive electrode current collector paste was prepared as follows. As a current collector, Cu powder and acetylene black powder were used, and as a solid electrolyte, the solid electrolyte used in the above (1) was used. The Cu powder, the acetylene black powder, and the solid electrolyte powder were mixed at a mass ratio of 40:10:50. Subsequently, a positive electrode current collector paste was prepared by adding and mixing 10 parts by mass of ethyl cellulose serving as a binder for a positive electrode and 50 parts by mass of dihydroterpineol serving as a solvent to 100 parts by mass of the mixed powder.

A solid electrolyte paste for screen printing was prepared as follows. A solid electrolyte paste for screen printing was prepared by using, as a solid electrolyte, the solid electrolyte used in the above (1) and adding and mixing 10 parts by mass of ethyl cellulose serving as a binder and 50 parts by mass of dihydroterpineol serving as a solvent to 100 parts by mass of the solid electrolyte powder.

Subsequently, a positive electrode active material layer was formed by printing a positive electrode active material paste on the solid electrolyte layer of the PET film with the solid electrolyte layer obtained in the above (1) so that the positive electrode active material paste had a thickness of 10 μm using a screen printing method and drying the positive electrode active material paste at 80° C. for 5 minutes. Subsequently, a positive electrode current collector layer was formed by printing a positive electrode current collector paste on the positive electrode active material layer using a screen printing method so that the positive electrode current collector paste had a thickness of 5 μm and drying the positive electrode current collector paste at 80° C. for 5 minutes. Subsequently, a positive electrode active material layer was formed by printing a positive electrode active material paste again on the positive electrode current collector layer so that the positive electrode active material paste had a thickness of 10 μm using a screen printing method and drying the positive electrode active material paste at 80° C. for 5 minutes. Thus, a positive electrode was formed on the solid electrolyte layer. Subsequently, a side margin layer containing a solid electrolyte was formed by printing the solid electrolyte paste for screen printing in a region of the solid electrolyte layer in which the positive electrode was not formed so that the solid electrolyte paste for screen printing had substantially the same plane height as the positive electrode and drying the solid electrolyte paste for screen printing at 80° C. for 10 minutes. After that, the PET film was peeled off. In this way, the positive electrode in which the positive electrode active material layer/positive electrode current collector layer/positive electrode active material layer were laminated in this order and the side margin layer were formed on a main surface of the solid electrolyte layer to obtain a positive electrode unit.

### (3) Preparation of Negative Electrode Unit

A negative electrode active material paste was prepared as follows. An anatase type TiO₂ powder was used as a negative electrode active material. A negative electrode active material paste was obtained by adding and mixing 15 parts by mass of ethyl cellulose serving as a binder for a negative electrode and 65 parts by mass of dihydroterpineol serving as a solvent to 100 parts by mass of the TiO₂ powder.

A negative electrode current collector paste was prepared as follows. Cu powder and acetylene black powder were used as a current collector and the solid electrolyte used in the above (1) was used as a solid electrolyte. The Cu powder, the acetylene black powder, and the solid electrolyte were mixed at a mass ratio of 40:10:50. Subsequently, a negative electrode current collector paste was prepared by adding and mixing 10 parts by mass of ethyl cellulose serving as a binder for a negative electrode and 50 parts by mass of dihydroterpineol serving as a solvent to 100 parts by mass of the mixed powder.

A LATGP compound paste was prepared as follows.

First, a LATGP compound was prepared as follows.

Lithium acetate (CH₃COOLi), aluminum s-butoxide (Al(OC₄H₉)₃), Titanium (IV) tetrabutoxide (Ti[O(CH₂)₃CH₃]₄), tetraethoxygermanium (Ge(OC₂H₅)₄), ammonium dihydrogen phosphate (NH₄H₂PO₄), n-butyl alcohol (n-C₄H₉OH), and ion exchange water (H₂O) were prepared as starting materials. Lithium acetate, aluminum s-butoxide, titanium (IV) tetrabutoxide, tetraethoxygermanium, and ammonium dihydrogen phosphate were weighed so that a molar ratio of Li:Al:Ti:Ge:PO₄ was 1.5:0.5:0.01:1.49:3.0. Subsequently, lithium acetate, aluminum s-butoxide, titanium (IV) tetrabutoxide, and tetraethoxygermanium were dissolved in n-butyl alcohol. This was called as Solution A. Subsequently, ammonium dihydrogen phosphate was dissolved in ion exchange water. This was called as Solution B. A sol of a LATGP compound precursor was prepared by adding Solution A to Solution B and stirring a mixture with a magnetic stirrer for 2 hours. The precursor sol was washed with ethanol and ion-exchanged water, and then the LATGP precursor sol was collected through suction filtration and dried at 100° C. The LATGP compound powder was obtained by calcining the obtained powder at 500° C. for 4 hours in an air atmosphere. The particle size of the obtained LATGP compound powder was measured using a laser diffraction/scattering particle size distribution measuring device and the average particle size was 100 nm. A composition of the LATGP compound powder was obtained by dissolving the LATGP compound powder with acid and measuring the amounts of Li, Al, Ti, Ge, and P in the obtained solution in a quantitative manner using inductively coupled plasma optical emission spectroscopy (ICP-AES). The composition of the obtained LATGP compound powder was Li_{1.5}Al_{0.5}Ti_{0.01}Ge_{1.49}(PO₄)₃.

100 parts by mass of ethanol and 200 parts by mass of toluene which served as solvents were added to 100 parts by mass of the LATGP compound powder and mixed in a wet manner using a ball mill. After that, a LATGP compound paste was obtained by further adding 16 pans by mass of polyvinyl butyral serving as a binder for a solid electrolyte and 4.8 parts by mass of benzyl butyl phthalate serving as a plasticizer and mixing and dispersing the mixture. In the subsequent steps, in a case where it was desired to reduce a thickness of a LATGP compound layer, a paste was prepared in which a mass part of the LATGP compound powder was decreased and a solid content concentration of the LATGP compound powder was low. On the other hand, in a case where it was desired to increase a thickness of a LATGP compound layer, a paste was prepared in which a mass part of the LATGP compound powder was increased and a solid content concentration of the LATGP compound powder was high.

Subsequently, a LATGP compound layer having a thickness of 2 μm was formed by printing the LATGP compound paste on the solid electrolyte layer of a PET film with a solid electrolyte layer obtained in the above (1) using a screen printing method and drying it at 80° C. for 5 minutes. Subsequently, a negative electrode active material layer having a thickness of 10 μm was formed by printing the negative electrode active material paste on the LATGP compound layer using a screen printing method and drying it at 80° C. for 5 minutes. Subsequently, a negative electrode current collector layer having a thickness of 5 μm was formed by printing the negative electrode current collector paste on the negative electrode active material layer using a screen printing method and drying it at 80° C. for 5 minutes. Subsequently, a negative electrode active material layer having a thickness of 10 μm was formed by printing the negative electrode active material paste again on the negative electrode current collector layer using a screen printing method and drying it at 80° C. for 5 minutes. Subsequently, a LATGP compound layer having a thickness of 2 μm was formed by printing the LATGP compound paste again on the negative electrode active material layer using a screen printing method and drying it at 80° C. for 5 minutes. Thus, a negative electrode disposed between the LATGP compound layers was formed on the solid electrolyte layer. Subsequently, a side margin layer containing a solid electrolyte was formed by screen-printing the solid electrolyte paste for screen printing used in the above (2) in a region of the solid electrolyte layer in which the negative electrode disposed between the LATGP compound layers was not formed so that the solid electrolyte paste for screen printing had substantially the same plane height as the negative electrode disposed between the LATGP compound layers and drying it at 80° C. for 10 minutes. After that, the PET film was peeled off. In this way, the negative electrode in which the LATGP compound layer/negative electrode active material layer/negative electrode current collector layer/negative electrode active material layer/LATGP compound layer were laminated in this order and the side margin layer were formed on a main surface of the solid electrolyte layer to obtain a negative electrode unit.

(4) Preparation of all-Solid-State Battery

5 sheets of the solid electrolyte sheets prepared in the above (1) overlapped and 25 sheets of the positive electrode units prepared in the above (2) and 25 sheets of the negative electrode units prepared in the above (3) were alternately laminated on the top of the laminated body so that the positive electrode active material of each of the positive electrode units was on the upper side and the LATGP compound layer of each of the negative electrode units was on the upper side. At this time, the positive electrode units and the negative electrode units were laminated in a staggered manner so that the positive electrode current collector layer of the positive electrode unit extended only to one end surface and the negative electrode current collector layer of the negative electrode unit extended only to the opposite end surface. 6 sheets of the solid electrolyte sheets were laminated on the top of the last laminated negative electrode unit. The laminated body obtained in this way was molded through thermocompression bonding and then cut to prepare a laminated chip. The laminated chip was sintered by subjecting the obtained laminated chip to a binder degreasing process and sintering. The binder degreasing process and the sintering were performed in a nitrogen atmosphere by raising the temperature to a sintering temperature of 800° C. at an increasing rate of 200° C./hour and holding the temperature for 2 hours.

An all-solid-state battery was prepared by forming the positive electrode terminal on the surface of the obtained sintered body in which the positive electrode current collectors were exposed and forming the negative electrode terminal on the surface of the obtained sintered body in which the negative electrode current collectors were exposed.

### (5) Evaluation

### (Porosity of Solid Electrolyte Layer, and Thickness of LATGP Compound Layer)

The all-solid-state battery was cut along the lamination direction and a polished cross section was obtained using a cross-section polisher (CP). The obtained cross section was observed using a scanning electron microscope (SEM) and the porosity of the solid electrolyte layer and the thickness of the LATGP compound layer were measured. The porosity of the solid electrolyte layer was calculated using the following procedure. First, an SEM photograph of the solid electrolyte layer taken at a magnification of 5000 times was binarized so that the void parts were black and the solid electrolyte part was white and the number of pixels in each was measured. Furthermore, the porosity of the solid electrolyte layer per layer was obtained by calculating the number of pixels in the black portion relative to the total number of pixels in the solid electrolyte layer. The porosities of the solid electrolyte layers at a total of 20 locations were calculated using the same procedure. The thickness of the LATGP compound layer was calculated using the following procedure. In the SEM photograph taken at a magnification of 2000 times, the thickness was measured at five locations in the same LATGP compound layer and the average value was taken as the thickness of the LATGP compound layer per layer. The thicknesses of the LAGP compound layers were measured at a total of 20 locations using the same measurement method. The average values are shown in Table 1A which will be shown below.

### (Discharge Characteristics)

The discharge characteristics of the all-solid-state battery were evaluated from the ratio of the discharge capacity at a discharge rate of 10 C to the discharge capacity at a discharge rate of 0.1 C (10 C/0.1 C rate characteristics).

Constant current charging (CC charging) of the all-solid-state battery was performed at a constant current of 0.1 C until the battery voltage reached 3.2 V in an environment of 25° C. After that, the all-solid-state battery was discharged at a constant current of 0.1 C until the battery voltage reached 0 V (CC discharging) and the discharge capacity at 0.1 C was measured. Subsequently, the all-solid-state battery was charged again under the above-described conditions and discharged at a discharge rate of 10 C until the battery voltage reached 0 V and the discharge capacity at 10 C was measured. The results are shown in Table 1A which will be shown below.

### Examples 2 to 6, Comparative Example 1

In Examples 2 to 6, all-solid-state batteries were prepared and evaluated in the same manner as in Example 1, except that the composition of the LATGP compound powder was changed to the composition shown in Table 1 A which will be shown below. In Comparative Example 1, an all-solid-state battery was prepared and evaluated in the same manner as in Example 1, except that the LATGP compound layer was not formed in the negative electrode unit. The results are shown in Table 1 A.

### Examples 7 to 11, Comparative Example 2

In Examples 7 to 11, all-solid-state batteries were prepared and evaluated in the same manner as in Example 1, except that Li_{1.7}Al_{0.7}Ge_{1.3}(PO₄)₃ powder was used as a solid electrolyte and that the composition of the LATGP compound powder was set to the composition as shown in Table 1A which will be shown below. In Comparative Example 2, an all-solid-state battery was produced and evaluated in the same manner as in Example 1, except that Li_{1.7}Al_{0.3}Ge_{1.3}(PO₄)₃ powder was used as a solid electrolyte and that the LATGP compound layer was not formed in the negative electrode unit. The results are shown in Table 1A.

### Examples 12 to 16, Comparative Example 3

In Examples 12 to 16, all-solid-state batteries were prepared and evaluated in the same manner as in Example 1, except that Li_{1.3}Al_{0.3}Ge_{1.7}(PO₄)₃ powder was used as a solid electrolyte and that the composition of the LATGP compound powder was set to the composition as shown in Table 1A which will be shown below. In Comparative Example 3, an all-solid-state battery was prepared and evaluated in the same manner as in Example 1, except that Li_{1.3}Al_{0.3}Ge_{1.7}(PO₄)₃ powder was used as a solid electrolyte and that the LATP compound layer was not formed in the negative electrode unit. The results are shown in Table 1A.

### Examples 17 to 21, Comparative Example 4

In Examples 17 to 21, all-solid-state batteries were prepared and evaluated in the same manner as in Example 1, except that Li_{1.2}Al_{0.2}Ge_{1.8}(PO₄)₃ powder was used as a solid electrolyte and that the composition of the LATGP compound powder was set to the composition as shown in Table 1B which will be shown below. In Comparative Example 4, an all-solid-state battery was prepared and evaluated in the same manner as in Example 1, except that Li_{1.2}Al_{0.2}Ge_{1.8}(PO₄)₃ powder was used as a solid electrolyte and that the LATGP compound layer was not formed in the negative electrode unit. The results are shown in Table 1B.

### Examples 22 to 26, Comparative Example 5

In Examples 22 to 26, all-solid-state batteries were prepared and evaluated in the same manner as in Example 1, except that Li_{1.1}Al_{0.1}Ge_{1.9}(PO₄)₃ powder was used as a solid electrolyte and that the composition of the LATGP compound powder was set to the composition as shown in Table 1B which will be shown below. In Comparative Example 5, an all-solid-state battery was prepared and evaluated in the same manner as in Example 1, except that Li_{1.1}Al_{0.1}Ge_{1.9}(PO₄)₃ powder was used as a solid electrolyte and that the LATGP compound layer was not formed in the negative electrode unit. The results are shown in Table 1B.

### Comparative Examples 6 to 11

In Comparative Example 6, an all-solid-state battery was prepared and evaluated in the same manner as in Example 1, except that Li_{2.0}Al_{1.0}Ge_{1.0}(PO₄)₃ powder was used as a solid electrolyte and that the LATGP compound layer was not formed in the negative electrode unit. In Comparative Examples 7 to 11, all-solid-state batteries were prepared and evaluated in the same manner as in Example 1, except that Li_{2.0}Al_{1.0}Ge_{1.0}(PO₄)₃ powder was used as a solid electrolyte and that the composition of the LATGP compound powder was set to the composition as shown in Table 1B which will be shown below. The results are shown in Table 1B.

### Examples 27 and 28

In Example 27, an all-solid-state battery was prepared and evaluated in the same manner as in Comparative Example 1, except that TiO₂ powder covered with a LATGP compound was used as a negative electrode active material. The results are shown in Table 1B. The TiO₂ powder covered with a LATGP compound was prepared using the following produce. As starting materials, lithium acetate (CH₃COOLi), aluminum s-butoxide (Al(OC₄H₉)₃), titanium (IV) tetrabutoxide (Ti[O(CH₂)₃CH₃]₄), tetraethoxygermanium (Ge(OC₂H₅)₄), ammonium dihydrogen phosphate (NH₄H₂PO₄), n-butyl alcohol (n-C₄H₉OH), ion exchange water (H₂O), and anatase type titanium oxide (TiO₂) were prepared. First, lithium acetate, aluminum s-butoxide, titanium (IV) tetrabutoxide, tetraethoxygermanium, and ammonium dihydrogen phosphate were weighed so that a molar ratio of Li:Al:Ti:Ge:PO₄ was 1.5:0.5:0.01:1.49:3.0. Subsequently, lithium acetate, aluminum s-butoxide, titanium (IV) tetrabutoxide, and tetraethoxygermanium were dissolved in n-butyl alcohol. This was called as Solution A. Subsequently, ammonium dihydrogen phosphate was dissolved in ion exchange water and TiO₂ powder was added to this solution and dispersed using a magnetic stirrer (this was called as Solution B). A sol of the LATGP compound precursor was generated on the surface of TiO₂ powder by adding Solution A to Solution B and stirring it with a magnetic stirrer for 2 hours. The TiO₂ powder covered with the sol of the precursor was washed with ethanol and ion exchange water and then collected through suction filtration and dried at 100° C. The obtained powder was calcined at 500° C. for 4 hours in an air atmosphere to obtain TiO₂ powder covered with the LATGP compound.

After embedding the TiO₂ powder covered with the obtained LATGP compound in a resin, thin pieces were prepared. Then, STEM images were observed using a scanning transmission electron microscope-energy dispersive X-ray spectroscopy (STEM-EDS) and elemental mapping was performed using EDS. As a result, it was confirmed that more than 50% of the surface of the TiO₂ powder was covered with the LATGP compound and that the thickness of the LATGP compound was 50 nm or less.

In Example 28, an all-solid-state battery was prepared and evaluated in the same manner as in Example 1, except that the TiO₂ powder covered with the LATGP compound of Example 27 was used as a negative electrode active material. The results are shown in Table 1B.

TABLE 1A

| | | | LATGP compound layer | | | | | | | | | Negative | |
|---|---|---|---|---|---|---|---|---|---|---|---|---|---|
| | | | Composition of material | | | | | | | | | electrode | 10 C/0.1 C |
| | Solid electrolyte layer | | | | | Ge | | | | | | active | rate |
| | | Porosity | Li | Al | Ti | (2 − | | | | | Thickness | material | characteristics |
| | Material | (%) | (1 + y) | (y) | (z) | y − x) | P | O | y + z | z/y | (μm) | layer | (%) |
| Example 1 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | TiO₂ | 87 |
| Example 2 | Li_{1.5}Al_{0.5}Ge_{1.5}(PO₄)₃ | 40 | 1.5 | 0.5 | 0.10 | 1.40 | 3 | 12 | 0.60 | 0.20 | 1.0 | TiO₂ | 89 |
| Example 3 | Li_{1.5}Al_{0.5}Ge_{1.5}(PO₄)₃ | 40 | 1.5 | 0.5 | 0.20 | 1.30 | 3 | 12 | 0.70 | 0.40 | 1.0 | TiO₂ | 89 |
| Example 4 | Li_{1.5}Al_{0.5}Ge_{1.5}(PO₄)₃ | 40 | 1.5 | 0.5 | 0.50 | 1.00 | 3 | 12 | 1.00 | 1.00 | 1.0 | TiO₂ | 86 |
| Example 5 | Li_{1.5}Al_{0.5}Ge_{1.5}(PO₄)₃ | 40 | 1.5 | 0.5 | 0.60 | 0.90 | 3 | 12 | 1.10 | 1.20 | 1.0 | TiO₂ | 82 |
| Example 6 | Li_{1.5}Al_{0.5}Ge_{1.5}(PO₄)₃ | 40 | 1.5 | 0.5 | 0.10 | 1.40 | 3 | 12 | 0.60 | 0.20 | 1.0 | TiO₂ | 85 |
| Comparative | Li_{1.5}Al_{0.5}Ge_{1.5}(PO₄)₃ | 40 | — | | | | | | | | | TiO₂ | 75 |
| Example 1 | | | | | | | | | | | | | |
| Example 7 | Li_{1.7}Al_{0.7}Ge_{1.3}(PO₄)₃ | 40 | 1.7 | 0.7 | 0.01 | 1.29 | 3 | 12 | 0.71 | 0.01 | 1.0 | TiO₂ | 86 |
| Example 8 | Li_{1.7}Al_{0.7}Ge_{1.3}(PO₄)₃ | 40 | 1.7 | 0.7 | 0.10 | 1.20 | 3 | 12 | 0.80 | 0.14 | 1.0 | TiO₂ | 87 |
| Example 9 | Li_{1.7}Al_{0.7}Ge_{1.3}(PO₄)₃ | 40 | 1.7 | 0.7 | 0.20 | 1.10 | 3 | 12 | 0.90 | 0.29 | 1.0 | TiO₂ | 86 |
| Example 10 | Li_{1.7}Al_{0.7}Ge_{1.3}(PO₄)₃ | 40 | 1.7 | 0.7 | 0.30 | 1.00 | 3 | 12 | 1.00 | 0.43 | 1.0 | TiO₂ | 84 |
| Example 11 | Li_{1.7}Al_{0.7}Ge_{1.3}(PO₄)₃ | 40 | 1.7 | 0.7 | 0.40 | 0.90 | 3 | 12 | 1.10 | 0.57 | 1.0 | TiO₂ | 81 |
| Comparative | Li_{1.7}Al_{0.7}Ge_{1.3}(PO₄)₃ | 40 | — | | | | | | | | | TiO₂ | 73 |
| Example 2 | | | | | | | | | | | | | |
| Example 12 | Li_{1.3}Al_{0.3}Ge_{1.7}(PO₄)₃ | 40 | 1.3 | 0.3 | 0.01 | 1.69 | 3 | 12 | 0.3 | 0.03 | 1.0 | TiO₂ | 84 |
| Example 13 | Li_{1.3}Al_{0.3}Ge_{1.7}(PO₄)₃ | 40 | 1.3 | 0.3 | 0.20 | 1.50 | 3 | 12 | 0.50 | 0.67 | 1.0 | TiO₂ | 86 |
| Example 14 | Li_{1.3}Al_{0.3}Ge_{1.7}(PO₄)₃ | 40 | 1.3 | 0.3 | 0.50 | 1.20 | 3 | 12 | 0.80 | 1.67 | 1.0 | TiO₂ | 85 |
| Example 15 | Li_{1.3}Al_{0.3}Ge_{1.7}(PO₄)₃ | 40 | 1.3 | 0.3 | 0.70 | 1.00 | 3 | 12 | 1.00 | 2.33 | 1.0 | TiO₂ | 83 |
| Example 16 | Li_{1.3}Al_{0.3}Ge_{1.7}(PO₄)₃ | 40 | 1.3 | 0.3 | 0.80 | 0.90 | 3 | 12 | 1.10 | 2.67 | 1.0 | TiO₂ | 80 |
| Comparative | Li_{1.3}Al_{0.3}Ge_{1.7}(PO₄)₃ | 40 | — | | | | | | | | | TiO₂ | 72 |
| Example 3 | | | | | | | | | | | | | |

TABLE 1B

| | | | LATGP compound layer | | | | | | | | | Negative | |
|---|---|---|---|---|---|---|---|---|---|---|---|---|---|
| | | | Composition of material | | | | | | | | | electrode | 10 C/0.1 C |
| | Solid electrolyte layer | | | | | Ge | | | | | | active | rate |
| | | Porosity | Li | Al | Ti | (2 − | | | | | Thickness | material | characteristics |
| | Material | (%) | (1 + y) | (y) | (z) | y − x) | P | O | y + z | z/y | (μm) | layer | (%) |
| Example 17 | Li_{1.2}Al_{0.2}Ge_{1.8}(PO₄)₃ | 40 | 1.2 | 0.2 | 0.01 | 1.79 | 3 | 12 | 0.21 | 0.05 | 1.0 | TiO₂ | 83 |
| Example 18 | Li_{1.2}Al_{0.2}Ge_{1.8}(PO₄)₃ | 40 | 1.2 | 0.2 | 0.20 | 1.60 | 3 | 12 | 0.40 | 1.00 | 1.0 | TiO₂ | 84 |
| Example 19 | Li_{1.2}Al_{0.2}Ge_{1.8}(PO₄)₃ | 40 | 1.2 | 0.2 | 0.30 | 1.50 | 3 | 12 | 0.50 | 1.50 | 1.0 | TiO₂ | 84 |
| Example 20 | Li_{1.2}Al_{0.2}Ge_{1.8}(PO₄)₃ | 40 | 1.2 | 0.2 | 0.80 | 1.00 | 3 | 12 | 1.00 | 4.00 | 1.0 | TiO₂ | 80 |
| Example 21 | Li_{1.2}Al_{0.2}Ge_{1.8}(PO₄)₃ | 40 | 1.2 | 0.2 | 0.90 | 0.90 | 3 | 12 | 1.10 | 4.50 | 1.0 | TiO₂ | 78 |
| Comparative | Li_{1.2}Al_{0.2}Ge_{1.8}(PO₄)₃ | 40 | — | | | | | | | | | TiO₂ | 71 |
| Example 4 | | | | | | | | | | | | | |
| Example 22 | Li_{1.1}Al_{0.1}Ge_{1.9}(PO₄)₃ | 40 | 1.1 | 0.1 | 0.01 | 1.89 | 3 | 12 | 0.11 | 0.10 | 1.0 | TiO₂ | 81 |
| Example 23 | Li_{1.1}Al_{0.1}Ge_{1.9}(PO₄)₃ | 40 | 1.1 | 0.1 | 0.20 | 1.70 | 3 | 12 | 0.30 | 2.00 | 1.0 | TiO₂ | 82 |
| Example 24 | Li_{1.1}Al_{0.1}Ge_{1.9}(PO₄)₃ | 40 | 1.1 | 0.1 | 0.40 | 1.50 | 3 | 12 | 0.50 | 4.00 | 1.0 | TiO₂ | 82 |
| Example 25 | Li_{1.1}Al_{0.1}Ge_{1.9}(PO₄)₃ | 40 | 1.1 | 0.1 | 0.90 | 1.00 | 3 | 12 | 1.00 | 9.00 | 1.0 | TiO₂ | 79 |
| Example 26 | Li_{1.1}Al_{0.1}Ge_{1.9}(PO₄)₃ | 40 | 1.1 | 0.1 | 1.00 | 0.90 | 3 | 12 | 1.10 | 10.00 | 1.0 | TiO₂ | 77 |
| Comparative | Li_{1.1}Al_{0.1}Ge_{1.9}(PO₄)₃ | 40 | — | | | | | | | | | TiO₂ | 69 |
| Example 5 | | | | | | | | | | | | | |
| Comparative | Li_{2.0}Al_{1.0}Ge_{1.0}(PO₄)₃ | 40 | — | | | | | | | | | TiO₂ | 55 |
| Example 6 | | | | | | | | | | | | | |
| Comparative | Li_{2.0}Al_{1.0}Ge_{1.0}(PO₄)₃ | 40 | 2.0 | 1.0 | 0.01 | 0.99 | 3 | 12 | 1.01 | 0.01 | 1.0 | TiO₂ | 60 |
| Example 7 | | | | | | | | | | | | | |
| Comparative | Li_{2.0}Al_{1.0}Ge_{1.0}(PO₄)₃ | 40 | 2.0 | 1.0 | 0.10 | 0.90 | 3 | 12 | 1.10 | 0.10 | 1.0 | TiO₂ | 62 |
| Example 8 | | | | | | | | | | | | | |
| Comparative | Li_{2.0}Al_{1.0}Ge_{1.0}(PO₄)₃ | 40 | 2.0 | 1.0 | 0.50 | 0.50 | 3 | 12 | 1.50 | 0.50 | 1.0 | TiO₂ | 61 |
| Example 9 | | | | | | | | | | | | | |
| Comparative | Li_{2.0}Al_{1.0}Ge_{1.0}(PO₄)₃ | 40 | 2.0 | 1.0 | 0.80 | 0.20 | 3 | 12 | 1.80 | 0.80 | 1.0 | TiO₂ | 59 |
| Example 10 | | | | | | | | | | | | | |
| Comparative | Li_{2.0}Al_{1.0}Ge_{1.0}(PO₄)₃ | 40 | 2.0 | 1.0 | 0.90 | 0.10 | 3 | 12 | 1.90 | 0.90 | 1.0 | TiO₂ | 58 |
| Example 11 | | | | | | | | | | | | | |
| Example 27 | Li_{1.5}Al_{0.5}Ge_{1.5}(PO₄)₃ | 40 | — | | | | | | | | | LATGP- | 80 |
| | | | | | | | | | | | | covered | |
| | | | | | | | | | | | | TiO₂ | |
| Example 28 | Li_{1.5}Al_{0.5}Ge_{1.5}(PO₄)₃ | 40 | 1.5 | 0.5 | 0.01 | 1.49 | 3 | 12 | 0.60 | 0.2 | 1.0 | LATGP- | 92 |
| | | | | | | | | | | | | covered | |
| | | | | | | | | | | | | TiO₂ | |

It can be seen from the results shown in Tables 1A and 1B that the all-solid-state batteries of Examples 1 to 26 in which the LATGP compound layer was provided between the negative electrode active material layer containing the TiO₂ and the solid electrolyte layer containing the LAGP compound had higher 10C/0.1C rate characteristics and superior discharge characteristics than those of the all-solid-state batteries of Comparative Examples 1 to 6 which did not have a LATGP compound layer. Furthermore, it can be seen that the all-solid-state battery of Examples 1 to 26 in which x of the LAGP compound (Li₁₊ₓAlₓGe₂₋ₓ(PO₄)₃) was smaller than 1 had higher 10 C/1 C rate characteristics and superior discharge characteristics than those of the all-solid-state batteries in Comparative Examples 7 to 11 in which x was 1. In addition, it can be seen that the all-solid-state battery of Example 27 using the TiO₂ covered with the LATGP compound also had superior discharge characteristics compared to that of the all-solid-state battery of Comparative Example 1. Moreover, it can be seen that the all-solid-state battery of Example 28 which included the negative electrode active material layer containing the TiO₂ covered with the LATGP compound and the LATGP compound layer also had superior discharge characteristics.

### Examples 29 to 32, Comparative Example 12

In Example 29, an all-solid-state battery was produced and evaluated in the same manner as in Example 1, except that Li₄Ti₅O₁₂ powder was used as a negative electrode active material. In Comparative Example 12, an all-solid-state battery was prepared and evaluated in the same manner as in Example 1, except that Li₄Ti₅O₁₂ powder was used as a negative electrode active material, and except that an LATGP compound layer was not formed in the negative electrode unit. The results are shown in Table 2 which will be shown below, along with the results of Example 1.

In Example 30, TiO₂ powder was used as a negative electrode active material and acetylene black powder was used as a conductive auxiliary agent. TiO₂ powder and acetylene black powder were mixed at a weight ratio of 90:10. Subsequently, a negative electrode active material paste was obtained by adding and mixing 15 parts by mass of ethyl cellulose serving as a binder for a negative electrode and 65 parts by mass of dihydroterpineol serving as a solvent to 100 parts by mass of the mixed powder. An all-solid-state battery was prepared and evaluated in the same manner as in Example 1, except that this negative electrode active material paste was prepared. The results are shown in Table 2 which will be shown below.

In Example 31, a negative electrode active material paste was prepared as follows. First, TiO₂ powder, acetylene black powder, and a solid electrolyte (LAGP: Li_{1.5}Al_{0.5}Ge_{1.5}(PO₄)₃) powder were mixed in a mass ratio of 45:10:45. Subsequently, a negative electrode active material paste was obtained by adding and mixing 15 parts by mass of ethyl cellulose serving as a binder for a negative electrode and 65 parts by mass of dihydroterpineol serving as a solvent to 100 parts by mass of the mixed powder. An all-solid-state battery was prepared and evaluated in the same manner as in Example 1, except that this negative electrode active material paste was prepared. The results are shown in Table 2 which will be shown below.

In Example 32, a negative electrode active material paste was prepared as follows. First, the TiO₂ powder covered with the LATGP compound prepared in Example 28, acetylene black powder, and a solid electrolyte (LAGP: Li_{1.5}Al_{0.5}Ge_{1.5}(PO₄)₃) powder were mixed in a mass ratio of 45:10:45. Subsequently, a negative electrode active material paste was obtained by adding and mixing 15 parts by mass of ethyl cellulose serving as a binder for a negative electrode and 65 parts by mass of dihydroterpineol serving as a solvent to 100 parts by mass of the mixed powder. An all-solid-state battery was prepared and evaluated in the same manner as in Example 1, except that this negative electrode active material paste was prepared. The results are shown in Table 2 which will be shown below.

TABLE 2

| | | | LATGP compound layer | | | | | | | | | Negative | |
|---|---|---|---|---|---|---|---|---|---|---|---|---|---|
| | | | Composition of material | | | | | | | | | electrode | 10 C/0.1 C |
| | Solid electrolyte layer | | | | | Ge | | | | | | active | rate |
| | | Porosity | Li | Al | Ti | (2 − | | | | | Thickness | material | characteristics |
| | Material | (%) | (1 + y) | (y) | (z) | y − x) | P | O | y + z | z/y | (μm) | layer | (%) |
| Example 29 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | Li₄Ti₅O₁₂ | 89 |
| Comparative | Li_{1.5}Al_{0.5}Ge_{1.5}(PO₄)₃ | 40 | — | | | | | | | | | Li₄Ti₅O₁₂ | 76 |
| Example 12 | | | | | | | | | | | | | |
| Example 30 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | TiO₂ + | 89 |
| | | | | | | | | | | | | Acetylene | |
| | | | | | | | | | | | | black | |
| Example 31 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | TiO₂ + | 90 |
| | | | | | | | | | | | | Acetylene | |
| | | | | | | | | | | | | black + | |
| | | | | | | | | | | | | LAGP | |
| Example 32 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | LATGP- | 95 |
| | | | | | | | | | | | | covered | |
| | | | | | | | | | | | | TiO₂ + | |
| | | | | | | | | | | | | Acetylene | |
| | | | | | | | | | | | | black + | |
| | | | | | | | | | | | | LAGP | |
| Example 1 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | TiO₂ | 87 |

It can be seen from the results in Table 2 that, even in a case where Li₄Ti₅O₁₂ powder was used as the negative electrode active material, the all-solid-state battery in Example 29 including a LATGP compound layer had superior discharge characteristics compared to that of the all-solid-state battery in Comparative Example 12 in which a LATP compound layer was not provided. Furthermore, it can be seen from the results of Example 30 and Example 31 that 10 C/0.1 C rate characteristics were further higher by adding carbon that was acetylene black and a solid electrolyte to the negative electrode active material layer. Furthermore, it can be seen from the results of Example 32 that the all-solid-state battery in which the TiO₂ covered with the LATGP compound was used as the negative electrode active material and a negative electrode active material layer further contained acetylene black and a solid electrolyte had further superior discharge characteristics.

### Examples 33 to 38

When all-solid-state batteries were prepared, in the preparation of a solid electrolyte sheet, all-solid-state batteries were prepared and evaluated in the same manner as in Example 1, except that a porosity of a solid electrolyte layer was changed by adjusting a mass part of polyvinyl butyral serving as a binder for a solid electrolyte. The results are shown in Table 3 which will be shown below, along with the results of Example 1.

TABLE 3

| | | | LATGP compound layer | | | | | | | | | Negative | |
|---|---|---|---|---|---|---|---|---|---|---|---|---|---|
| | | | Composition of material | | | | | | | | | electrode | 10 C/0.1 C |
| | Solid electrolyte layer | | | | | Ge | | | | | | active | rate |
| | | Porosity | Li | Al | Ti | (2 − | | | | | Thickness | material | characteristics |
| | Material | (%) | (1 + y) | (y) | (z) | y − x) | P | O | y + z | z/y | (μm) | layer | (%) |
| Example 33 | Li_{1.5}Al_{0.5}Ge_{1.5}(PO₄)₃ | 44 | 1.5 | 0.5 | 0.01 | 1.49 | 3 | 12 | 0.51 | 0.02 | 1.0 | TiO₂ | 81 |
| Example 34 | Li_{1.5}Al_{0.5}Ge_{1.5}(PO₄)₃ | 43 | 1.5 | 0.5 | 0.01 | 1.49 | 3 | 12 | 0.51 | 0.02 | 1.0 | TiO₂ | 81 |
| Example 35 | Li_{1.5}Al_{0.5}Ge_{1.5}(PO₄)₃ | 41 | 1.5 | 0.5 | 0.01 | 1.49 | 3 | 12 | 0.51 | 0.02 | 1.0 | TiO₂ | 82 |
| Example 1 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | TiO₂ | 87 |
| Example 36 | Li_{1.5}Al_{0.5}Ge_{1.5}(PO₄)₃ | 35 | 1.5 | 0.5 | 0.01 | 1.49 | 3 | 12 | 0.51 | 0.02 | 1.0 | TiO₂ | 89 |
| Example 37 | Li_{1.5}Al_{0.5}Ge_{1.5}(PO₄)₃ | 30 | 1.5 | 0.5 | 0.01 | 1.49 | 3 | 12 | 0.51 | 0.02 | 1.0 | TiO₂ | 90 |
| Example 38 | Li_{1.5}Al_{0.5}Ge_{1.5}(PO₄)₃ | 20 | 1.5 | 0.5 | 0.01 | 1.49 | 3 | 12 | 0.51 | 0.02 | 1.0 | TiO₂ | 90 |

It can be seen from the results in Table 3 that, as the porosity of the solid electrolyte layer decreased, the 10 C/0.1 C rate characteristics tended to increase and the discharge characteristics of the all-solid-state batteries tended to improve.

### Examples 39 to 461

In Examples 39 to 46, all-solid-state batteries were prepared and evaluated in the same manner as in Example 1, except that thicknesses of the LATGP compound layer in the all-solid-state batteries after sintering were set to the values as shown in Table 4 which will be shown below. The thicknesses of the LATGP compound layer were adjusted by variously changing the solid content concentration of the LATGP compound paste used in screen printing and the printing thickness of the LATGP compound layer during printing. Particularly, in Examples 39 to 43 in which a thickness of the LATGP compound layer was less than 1 μm, fine particles of the LATGP compound powders having an average particle size of 5 nm were prepared by changing a stirring time to 10 minutes during the preparation of the LATGP compound powders. In addition, a LATGP compound paste with a solid content concentration of 5 to 50% was used in screen-printing. Thereby, the thicknesses of the LATGP compound layers after sintering were adjusted to less than 1 μm. The solid content concentration of the LATGP compound paste was adjusted by appropriately changing the mass part of the LATGP compound powder, and the blending amounts of a solvent, a binder for a solid electrolyte, and a plasticizer. The results are shown in Table 4, along with the results of Example 1.

TABLE 4

| | | | LATGP compound layer | | | | | | | | | Negative | |
|---|---|---|---|---|---|---|---|---|---|---|---|---|---|
| | | | Composition of material | | | | | | | | | electrode | 10 C/0.1 C |
| | Solid electrolyte layer | | | | | Ge | | | | | | active | rate |
| | | Porosity | Li | Al | Ti | (2 − | | | | | Thickness | material | characteristics |
| | Material | (%) | (1 + y) | (y) | (z) | y − x) | P | O | y + z | z/y | (μm) | layer | (%) |
| Example 1 | Li_{1.5}Al_{0.5}Ge_{1.5}(PO₄)₃ | 40 | 1.5 | 0.5 | 0.01 | 1.49 | 3 | 12 | 0.51 | 0.02 | 1.0 | TiO₂ | 87 |
| Example 39 | Li_{1.5}Al_{0.5}Ge_{1.5}(PO₄)₃ | 40 | 1.5 | 0.5 | 0.01 | 1.49 | 3 | 12 | 0.51 | 0.02 | 0.01 | TiO₂ | 88 |
| Example 40 | Li_{1.5}Al_{0.5}Ge_{1.5}(PO₄)₃ | 40 | 1.5 | 0.5 | 0.01 | 1.49 | 3 | 12 | 0.51 | 0.02 | 0.10 | TiO₂ | 89 |
| Example 41 | Li_{1.5}Al_{0.5}Ge_{1.5}(PO₄)₃ | 40 | 1.5 | 0.5 | 0.01 | 1.49 | 3 | 12 | 0.51 | 0.02 | 0.20 | TiO₂ | 89 |
| Example 42 | Li_{1.5}Al_{0.5}Ge_{1.5}(PO₄)₃ | 40 | 1.5 | 0.5 | 0.01 | 1.49 | 3 | 12 | 0.51 | 0.02 | 0.50 | TiO₂ | 89 |
| Example 43 | Li_{1.5}Al_{0.5}Ge_{1.5}(PO₄)₃ | 40 | 1.5 | 0.5 | 0.01 | 1.49 | 3 | 12 | 0.51 | 0.02 | 0.80 | TiO₂ | 88 |
| Example 44 | Li_{1.5}Al_{0.5}Ge_{1.5}(PO₄)₃ | 40 | 1.5 | 0.5 | 0.01 | 1.49 | 3 | 12 | 0.51 | 0.02 | 1.2 | TiO₂ | 87 |
| Example 45 | Li_{1.5}Al_{0.5}Ge_{1.5}(PO₄)₃ | 40 | 1.5 | 0.5 | 0.01 | 1.49 | 3 | 12 | 0.51 | 0.02 | 2.0 | TiO₂ | 85 |
| Example 46 | Li_{1.5}Al_{0.5}Ge_{1.5}(PO₄)₃ | 40 | 1.5 | 0.5 | 0.01 | 1.49 | 3 | 12 | 0.51 | 0.02 | 5.0 | TiO₂ | 83 |

It can be seen from the results in Table 4 that 10C/0.1C rate characteristics were superior in a case in which the thickness of the LATGP compound layer (intermediate layer) formed between the solid electrolyte layer and the negative electrode active material layer was 2.0 μm or less, the 10C/0.1C rate characteristics were more superior in a case in which the thickness of the LATGP compound layer were within the range of 0.01 μm or more and 1.2 μm or less, and the 10C/0.1C rate characteristics were particularly high in a case in which the thickness of the LATGP compound layer were within the range of 0.10 μm or more and 0.50 μm or less.

### REFERENCE SIGNS LIST

1 Positive electrode
1A Positive electrode current collector layer
1B Positive electrode active material layer
2 Negative electrode
2A Negative electrode current collector layer
2B Negative electrode active material layer
3 Solid electrolyte layer
4 Laminated body
5 Positive electrode terminal
6 Negative electrode terminal
20 Titanium compound powder
21 LATGP compound
22 Conductive auxiliary agent powder
25 Intermediate layer
30 LAGP compound powder
31 Porosity
40 Positive electrode active material powder
41 Conductive auxiliary agent powder

1. An all-solid-state battery, comprising:
a positive electrode including a positive electrode active material layer; a negative electrode including a negative electrode active material layer; and a solid electrolyte layer located between the positive electrode active material layer and the negative electrode active material layer, wherein
the negative electrode active material layer contains a titanium compound,
the solid electrolyte layer contains an LAGP compound represented by the following Expression (1): 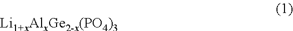
(in Expression (1), x is a number which satisfies 0<x<1), and
either one or both of an inside of the negative electrode active material layer and an interface between the negative electrode active material layer and the solid electrolyte layer contain an LATGP compound represented by the following Expression (2): 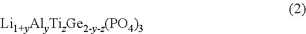
(in Expression (2), y and z are numbers which satisfy 0<y<1 and 0<z<1).

2. The all-solid-state battery according to claim 1, wherein the titanium compound contains either one or both of TiO₂ and Li₄Ti₅O₁₂.

3. The all-solid-state battery according to claim 1, wherein, in the Expression (2), y and z are numbers which satisfy 0.11≤y+z≤1 and 0.01≤z/y≤9.

4. The all-solid-state battery according to claim 1, wherein the negative electrode active material layer contains either one or both of a carbon-based material and the LAGP compound represented by the Expression (1).

5. The all-solid-state battery according to claim 1, wherein the solid electrolyte layer has a porosity of 40% or less.

6. The all-solid-state battery according to claim 2, wherein, in the Expression (2), y and z are numbers which satisfy 0.11≤y+z≤1 and 0.01≤z/y≤9.

7. The all-solid-state battery according to claim 2, wherein the negative electrode active material layer contains either one or both of a carbon-based material and the LAGP compound represented by the Expression (1).

8. The all-solid-state battery according to claim 3, wherein the negative electrode active material layer contains either one or both of a carbon-based material and the LAGP compound represented by the Expression (1).

9. The all-solid-state battery according to claim 6, wherein the negative electrode active material layer contains either one or both of a carbon-based material and the LAGP compound represented by the Expression (1).

10. The all-solid-state battery according to claim 2, wherein the solid electrolyte layer has a porosity of 40% or less.

11. The all-solid-state battery according to claim 3, wherein the solid electrolyte layer has a porosity of 40% or less.

12. The all-solid-state battery according to claim 4, wherein the solid electrolyte layer has a porosity of 40% or less.

13. The all-solid-state battery according to claim 6, wherein the solid electrolyte layer has a porosity of 40% or less.

14. The all-solid-state battery according to claim 7, wherein the solid electrolyte layer has a porosity of 40% or less.

15. The all-solid-state battery according to claim 8, wherein the solid electrolyte layer has a porosity of 40% or less.

16. The all-solid-state battery according to claim 9, wherein the solid electrolyte layer has a porosity of 40% or less.
